(19) United States
(12) Patent Application Publication
(10) Pub. No.: US 2011/0215769 A1
(43) Pub. Date: Sep. 8, 2011

(54) BATTERY CHARGING SYSTEM AND METHOD

(75) Inventor: CHUNG-HSIN HUANG, Tu-Cheng (TW)

(73) Assignee: HON HAI PRECISION INDUSTRY CO., LTD., Tu-Cheng (TW)

(21) Appl. No.: 12/838,484

(22) Filed: Jul. 18, 2010

(30) Foreign Application Priority Data
Mar. 8, 2010 (TW) 99106656

(51) Int. Cl. H02J 7/00

(52) U.S. Cl. 320/145

(57) ABSTRACT

An exemplary battery charging system includes a temperature sensor, a voltage measuring device, a processor and a charger. The temperature sensor is used for continuously sensing the current temperature of a rechargeable battery. The voltage measuring device is used for continuously measuring the current voltage U of the rechargeable battery. The processor is used for comparing the current temperature T with two temperature thresholds and comparing the current voltage U with two cut-off voltages, and generating a PWM control signal to the charger based on the results of the comparisons. The charger is used for charging the battery. When T reads as normal, the charger charges the battery using a first average current I1 and stops charging at U1. When T reads as hot, the charger charges the battery using a second average current I2 and stops charging at U2, wherein I1>I2, U1>U2.

### BACKGROUND

1. Technical Field

The present disclosure relates to a battery charging system and method for charging a rechargeable battery.

2. Description of Related Art

The temperature of rechargeable batteries increases quickly during recharging, thus rechargeable batteries are at risk of being damaged when the charging current is too high.

Therefore, it is desirable to provide a battery charging system and method which can overcome the above-mentioned limitations.

### BRIEF DESCRIPTION OF THE DRAWINGS

Many aspects of the present embodiments will be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a functional block diagram of a battery charging system, according to an exemplary embodiment.

FIG. 2 is a circuit diagram of a current adjusting module of the battery charging system of FIG. 1.

FIG. 3 is a graph showing a relationship of the charging current and the temperature of an exemplary rechargeable battery.

FIG. 4 is a graph showing a relationship of the charging cut-off voltage and the temperature of the exemplary rechargeable battery.

FIG. 5 is a flow chart of a battery charging method, according to another exemplary embodiment.

### DETAILED DESCRIPTION

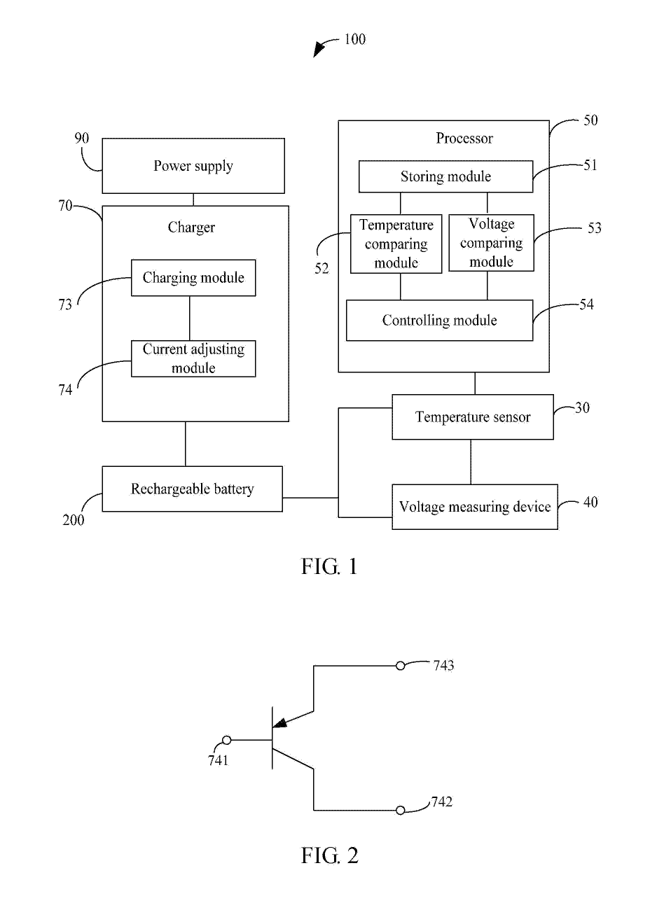

Referring to FIG. 1 and FIG. 2, a battery charging system 100, according to an exemplary embodiment, is configured for charging a rechargeable battery 200. The battery charging system 100 includes a temperature sensor 30, a voltage measuring device 40, a processor 50, and a charger 70. In the present embodiment, the rechargeable battery 200 is a lithium battery.

The temperature sensor 30 is positioned on an outer surface of the rechargeable battery 200, and is configured for continuously sensing a current temperature T of the rechargeable battery 200.

The voltage measuring device 40 is electrically connected to both a positive electrode and a negative electrode of the rechargeable battery 200, and is configured for continuously measuring a current voltage U of the rechargeable battery 200. In the present embodiment, the voltage measuring device 40 is a voltmeter.

The processor 50 includes a storing module 51, a temperature comparing module 52, a voltage comparing module 53, and a controlling module 54. The storing module 51 stores a first temperature threshold T1, a second temperature threshold T2, a third temperature threshold T3, and a fourth temperature threshold T4, as well as a first cut-off voltage U1, and a second cut-off voltage U2, wherein T3<T1<T2<T4 and U1>U2. In the present embodiment, T1 is about 10° C. (degrees Centigrade), T2 is about 45° C., T3 is about 0° C., T4 is about 60° C.; and U1 is about 4.05V (volts), and U2 is about 4.2V. The temperature comparing module 52 is configured for comparing the current temperature T of the rechargeable battery 200 with T1, T2, T3, and T4. The voltage comparing module 53 is configured for comparing the current voltage U of the rechargeable battery 200 with U1 and U2. The controlling module 54 is configured for generating a pulse-width modulation (PWM) control signal according to the results of the comparisons of the temperature and the voltage, and then sending the PWM control signal to the charger 70. The processor 50 controls the charger 70 by adjusting the duty cycle of the PWM control signal.

The charger 70 is electrically connected to a power supply 90, and includes a charging module 73 and a current adjusting module 74. The charging module 73 is configured for providing a charging current to the rechargeable battery 200. The current adjusting module 74 is configured for adjusting the charging current according to the PWM control signal of the processor 50. In the present embodiment, the current adjusting module 74 is a metal oxide semiconductor field effect transistor (MOSFET), and includes a base 741, a collector 742, and an emitter 743. The base 741 is connected to the processor 50 and is configured for receiving the PWM signal from the processor 50. The collector 742 is coupled with the rechargeable battery 200. The emitter 743 is coupled with the charging module 73. As such, the current adjusting module 74, according to the PWM control signal from the processor 50, can control connection between the charging module 73 and the rechargeable battery 200. When the PWM control signal is at high logic levels, the current adjusting module 74 charges the rechargeable battery 200 using a predetermined charging current; and when the PWM control signal is at low logic levels, the current adjusting module 74 stops charging the rechargeable battery 200. Therefore, the average charging current is proportional to the duty cycle of the PWM control signal.

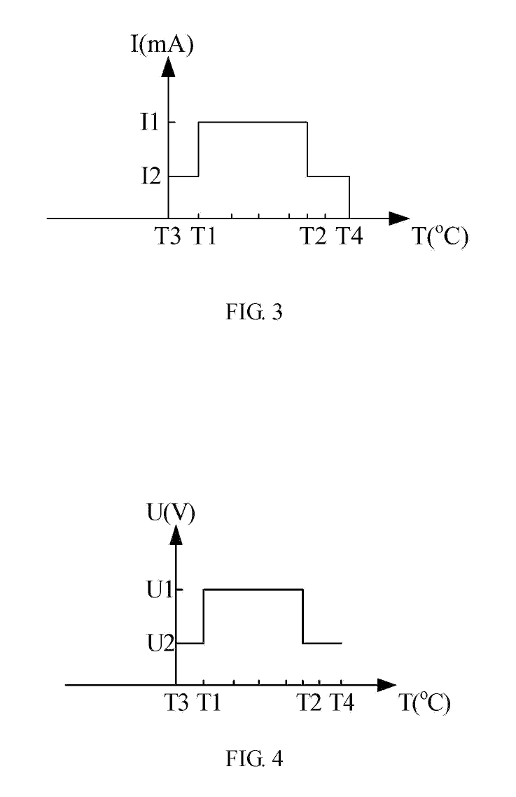

Referring to FIG. 3 and FIG. 4, in use, when the current temperature T falls into the range of the temperature thresholds T1˜T2 (this can be recognized from the temperature comparison results), the current adjusting module 74 controls the charging module 73 to charge the rechargeable battery 200 using a first average current I1. If the voltage of the rechargeable battery 200 reaches the first cut-off voltage U1 while the current temperature T remains in the range T1˜T2, the current adjusting module 74 controls the charging module 73 to stop charging the rechargeable battery 200. When the current temperature T falls into either of the ranges T3˜T1 or T2˜T4 (recognized from the temperature comparison results) before the current voltage U reaches the first cut-off voltage U1, the current adjusting module 74 controls the charging module 73 to charge the rechargeable battery 200 using a second average current I2, wherein I1>I2. When the voltage of the rechargeable battery 200 reaches the second cut-off voltage U2 and the current temperature T falls into either of the ranges T3˜T1 or T2˜T4, the charging of the rechargeable battery 200 is stopped. When the current temperature T exceeds the range T3˜T4 before the voltage of the rechargeable battery 200 reaches the second cut-off voltage U2, the current adjusting module 74 controls the charging module 73 to stop charging the rechargeable battery 200.

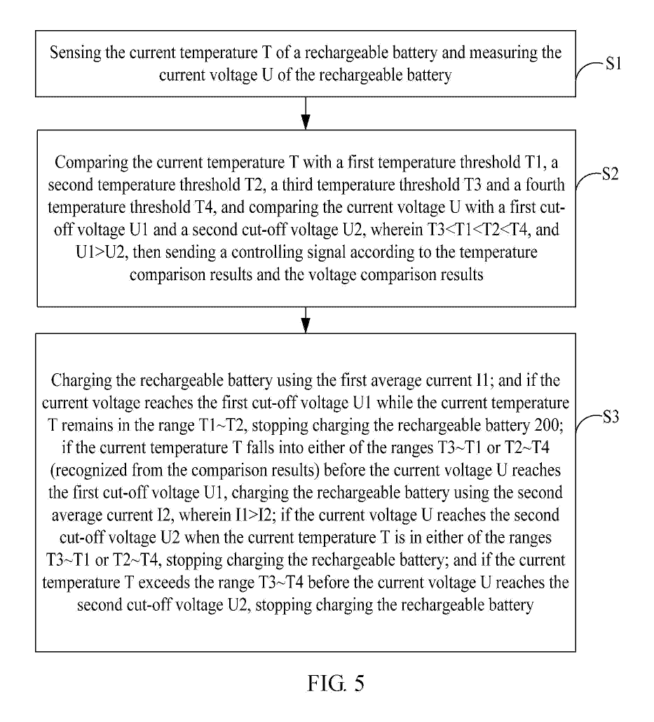

Referring to FIG. 5, a battery charging method is shown. The battery charging method includes the following steps:

S1: sensing the current temperature T of a rechargeable battery and measuring the current voltage U of the rechargeable battery.

S2: comparing the current temperature T with a first temperature threshold T1, a second temperature threshold T2, a third temperature threshold T3 and a fourth temperature threshold T4; and comparing the current voltage U with a first cut-off voltage U1 and a second cut-off voltage U2, wherein T3<T1<T2<T4 and U1>U2. Then, sending a PWM control signal according to the temperature comparison results and the voltage comparison results.

S3: charging the rechargeable battery using the first average current I1, and if the current voltage U reaches the first cut-off voltage U1 while the current temperature T remains in the range T1˜T2, the charging is stopped; if the current temperature T falls into either of the ranges T3˜T1 or T2˜T4 (recognized from the comparison results) before the current voltage U reaches the first cut-off voltage U1, the charging of the rechargeable battery continues using the second average current I2, wherein I1>I2; if the current voltage U reaches the second cut-off voltage U2 and the current temperature T falls into either of the ranges T3˜T1 or T2˜T4, or the current temperature T exceeds the range T3˜T4 before the current voltage U reaches the second cut-off voltage U2, then the charging of the rechargeable battery is stopped.

It will be understood that the above particular embodiments including methods are shown and described by way of illustration only. The principles and the features of the present embodiments may be employed in various and numerous other embodiments without departing from the scope of the invention as claimed and equivalents thereof. The above-described embodiments illustrate the scope of the invention but do not restrict the scope of the invention.

What is claimed is:

1. A battery charging system for charging a rechargeable battery, comprising:
a temperature sensor configured to be positioned on an outer surface of the rechargeable battery and configured for continuously sensing a current temperature T of the rechargeable battery;
a voltage measuring device configured to be electrically connected to both a positive electrode and a negative electrode of the rechargeable battery and configured for continuously measuring a current voltage U of the rechargeable battery;
a processor storing a first temperature threshold T1 and a second temperature threshold T2, and a first cut-off voltage U1 and a second cut-off voltage U2, wherein T1<T2, and U1>U2, the processor configured for:
comparing the current temperature T with the first and second temperature thresholds T1 and T2, and comparing the current voltage U with the first and second cut-off voltages U1 and U2; and
generating a PWM control signal according to the results of the temperature comparisons and the results of the voltage comparisons; and
a charger electrically connected to the processor and configured for electrical connection to a power supply, and further configured for providing a charging current to the rechargeable battery according the PWM control signal of the processor;
wherein when the current temperature T falls into the range T1˜T2, the charger is configured for charging the rechargeable battery using a first average current I1;
if the current voltage U reaches the first cut-off voltage U1 while the current temperature T remains in the range T1˜T2, the charger is configured for stopping charging the rechargeable battery;
if the current temperature T exceeds the range T1˜T2 before the current voltage U reaches the first cut-off voltage U1, the charger is configured for charging the rechargeable battery using a second average current I2, wherein I1>I2;
if the current voltage U reaches the second cut-off voltage U2 before the current temperature T exceeds the range T1˜T2, the charger is configured for stopping charging the rechargeable battery.

2. The battery charging system in claim 1, wherein the processor also stores a third temperature threshold T3 and a fourth temperature threshold T4, and T3<T1<T2<T4; if the current temperature T falls into either of the ranges T3˜T1 or T2˜T4 before the current voltage U reaches the first cut-off voltage U1, the charger is configured for charging the rechargeable battery using the second average current I2; if the current voltage U reaches the second cut-off voltage U2 when the current temperature T is in either of the ranges T3˜T1 or T2˜T4, the charger is configured for stopping charging the rechargeable battery; and if the current temperature T exceeds the range T3˜T4 before the current voltage U reaches the second cut-off voltage U2, the charger is configured for stopping charging the rechargeable battery.

3. The battery charging system in claim 1, wherein T1 is about 10° C., T2 is about 45° C., T3 is about 0° C., T4 is about 60° C., U1 is about 4.05V, and U2 is about 4.2V.

4. The battery charging system in claim 1, wherein the processor comprises a storing module, a temperature comparing module, a voltage comparing module, and a controlling module, the storing module stores the first and second temperature thresholds T1, T2 and the first and second cut-off voltages U1, U2; the temperature comparing module is configured for comparing the current temperature T with the first and second temperature thresholds T1 and T2; the voltage comparing module is configured for comparing the current voltage U with the first and second cut-off voltages U1 and U2; and the controlling module is configured for generating the PWM control signal according to the temperature comparison results and the voltage comparison results.

5. The battery charging system in claim 1, wherein the processor is configured to control the charger by adjusting the duty cycle of the PWM control signal.

6. The battery charging system in claim 5, wherein the charger includes a charging module and a current adjusting module, the charging module is configured for providing charging current to the rechargeable battery, and the current adjusting module is configured for adjusting the charging current according the PWM control signal of the processor.

7. The battery charging system in claim 6, wherein the current adjusting module comprises a metal oxide semiconductor field effect transistor.

8. The battery charging system in claim 7, wherein the current adjusting module comprises a base, a collector and an emitter, the base is arranged for receiving the PWM signal of the processor; the collector is configured for coupling to the rechargeable battery, and the emitter is coupled with the charging module.

9. The battery charging system in claim 1, wherein the rechargeable battery is a lithium battery.

10. The battery charging system in claim 1, wherein the voltage measuring device is a voltmeter.

11. A battery charging system for charging a rechargeable battery, comprising:
a temperature sensor configured to be positioned on an outer surface of the rechargeable battery and configured for continuously sensing a current temperature T of the rechargeable battery;
a voltage measuring device configured to be electrically connected to both a positive electrode and a negative electrode of the rechargeable battery and configured for continuously measuring a current voltage U of the rechargeable battery;
a processor storing a first temperature threshold T1 and a second temperature threshold T2, and a first cut-off voltage U1 and a second cut-off voltage U2, wherein T1<T2, and U1>U2, the processor configured for:
comparing the current temperature T with the first and second temperature thresholds T1 and T2, and comparing the current voltage U with the first and second cut-off voltages U1 and U2; and
generating a PWM control signal according to the results of the temperature comparisons and the results of the voltage comparisons; and
a power supply for providing electrical power; and
a charger electrically connected to the processor and the power supply, and configured for providing a charging current to the rechargeable battery according the PWM control signal of the processor;
wherein when the current temperature T falls into the range T1˜T2, the charger is configured for charging the rechargeable battery using a first average current I1;
if the current voltage U reaches the first cut-off voltage U1 while the current temperature T remains in the range T1˜T2, the charger is configured for stopping charging the rechargeable battery;
if the current temperature T exceeds the range T1˜T2 before the current voltage U reaches the first cut-off voltage U1, the charger is configured for charging the rechargeable battery using a second average current I2, wherein I1>I2;
if the current voltage U reaches the second cut-off voltage U2 before the current temperature T exceeds the range T1˜T2, the charger is configured for stopping charging the rechargeable battery.

12. A battery charging method for a rechargeable battery, the method comprising:
sensing a current temperature T of the rechargeable battery and measuring a current voltage U of the rechargeable battery;
comparing the current temperature T of the rechargeable battery with a predetermined first temperature threshold T1 and a predetermined second temperature threshold T2, and comparing the current voltage U of the rechargeable battery with a predetermined first cut-off voltage U1 and a predetermined second cut-off voltage U2, wherein T1<T2 and U1>U2, and then sending a pulse-width modulation (PWM) control signal according to the temperature comparison results and the voltage comparison results; and
charging the rechargeable battery using a first average current I1 when the current temperature T falls into the range T1˜T2; and if the current voltage U reaches the first cut-off voltage U1 while the current temperature T remains in the range T1˜T2, stopping charging the rechargeable battery; if the current temperature T exceeds the range T1˜T2 before the current voltage U reaches the first cut-off voltage U1, charging the rechargeable battery using a second average current I2, wherein I1>I2; and if the current voltage U reaches the second cut-off voltage U2 before the current temperature T exceeds the range T1˜T2, stopping charging the rechargeable battery.

13. The battery charging method in claim 11, further comprising comparing the current temperature T with a predetermined third temperature threshold T3 and a predetermined fourth temperature threshold T4, wherein T3<T1<T2<T4; and charging the rechargeable battery using the second average current I2 when the current temperature T falls into either of the ranges T3˜T1 or T2˜T4 before the current voltage U reaches the first cut-off voltage U1; and if the current voltage reaches the second cut-off voltage U2 when the current temperature T is in either of the ranges T3˜T1 or T2˜T4, stopping charging the rechargeable battery; and if the current temperature T exceeds the range T3˜T4 before the current voltage reaches the second cut-off voltage U2, stopping charging the rechargeable battery.

14. The battery charging method in claim 13, wherein T1 is about 10° C., T2 is about 45° C., T3 is about 0° C., T4 is about 60° C., U1 is about 4.05V, and U2 is about 4.2V.
